(19) United States
(12) Patent Application Publication
(10) Pub. No.: US 2026/0102045 A1
(43) Pub. Date: Apr. 16, 2026

(54) SPONGE FILTER

(71) Applicant: SERDAR PLASTIK, Sincan/Ankara (TR)

(72) Inventor: Mustafa Serdar TUTEK, Sincan/Ankara (TR)

(73) Assignee: SERDAR PLASTIK, Sincan/Ankara (TR)

(21) Appl. No.: 19/114,466

(22) PCT Filed: Sep. 22, 2023
(86) PCT No.: PCT/TR2023/051014

§ 371 Date: Mar. 24, 2025

(30) Foreign Application Priority Data
Sep. 23, 2022 (TR) 2022/014670

(51) Int. Cl. A47L 15/42

(52) U.S. Cl. CPC A47L 15/4204

(57) ABSTRACT

Sponge Filter The present invention comprises a dishwasher or washing machine arranged for cleaning dishes and similar products, having an automatic process cycle, a washing chamber and a tub completing this chamber, nozzles positioned to spray liquid into the washing chamber, and a pump connected to circulate it within the washing chamber. To complete this circulation circuit, the washing chamber and nozzles are characterized in that, within the circulation circuit, the circulating washing liquid is quickly filtered by a filter (sponge filter) having specially shaped conical absorbent protrusions and small pores of geometric shape and positioned so that the washing liquid passes quickly from an upper flow surface to a lower circulation surface, and directed to the circulation pump, ensuring that the circulation continues perfectly and quickly.

The present invention is characterised by being a filter (sponge filter) which is placed in the circulation flow path to pass the liquid faster, and the liquid passageways in the body of which are specially shaped, compared known filtering methods, for use in dishwashers and similar appliances having a liquid spray system, a liquid circulation system and a liquid filtration system.

It is characterized by being a durable, robust filter (sponge filter) made of thermoplastic polymer raw materials, which requiring a filtering system and used at the transition points of circulation elements, can quickly filter and transfer the intense flow it is exposed to with its specially shaped conical absorber structures and geometrically shaped small pores in systems with a tub defining a wash chamber.

### TECHNICAL FIELD OF THE INVENTION

It relates to dishwashers, washing machines, dryers and similar washing machines, especially those made for home use and for use in businesses where use is required. The present invention is a filter (sponge filter) consisting of graduated and geometrically shaped pores shaped in a conical structure, with a cleaning compartment where eating, drinking and cooking utensils can be placed to be washed, for use in washing devices where the cleaning of said equipment with a fixed or rotating liquid spraying, liquid filtering and liquid circulation system positioned according to the targeted washing areas is provided.

### State of the Art

In washing devices where filters that are easier to produce using known techniques are used; in the process of separating food particles in the washing liquid and transferring the washing liquid, the filtration efficiency is low because the residues accumulated in the pores slow down the flow and reduce the circulation performance of the washing liquid and the cleaning performance of the machine.

### BRIEF DESCRIPTION OF THE INVENTION

It is a washing/cleaning machine where cooking and eating utensils (forks, spoons, glasses, plates, pots, etc.) that require cleaning in dishwashers and similar washing machines are placed to be washed and these utensils are cleaned. The dishwasher may include a filter system to separate/remove impurities from the liquid circulating on the dishes during the washing process. The more successful this filter system is in separating/removing the dirt in the washing liquid, its filtration speed and reintroducing the cleaned water into the system, the faster and cleaner the washing process will be.

The present invention comprises a dishwasher or washing machine arranged for cleaning dishes and similar products, having an automatic process cycle, a washing chamber and a tub completing this chamber, nozzles positioned to spray liquid into the washing chamber, and a pump connected to circulate it within the washing chamber. To complete this circulation circuit, the washing chamber and nozzles are characterized in that, within the circulation circuit, the circulating washing liquid is quickly filtered by a filter (sponge filter) having specially shaped conical absorbent protrusions and small pores of geometric shape and positioned so that the washing liquid passes quickly from an upper flow surface to a lower circulation surface, and directed to the circulation pump, ensuring that the circulation continues perfectly and quickly.

In existing products, it is necessary to keep the hole diameters large for the rapid passage of water, which causes the residues to pass through the filter and the washing liquid cannot be filtered, reducing the cleaning performance of the machine. When the holes are made smaller, the water is filtered better and the dishes are cleaned better, but the passage speed of the water decreases, reducing the efficiency of the machine. With this invention, it is aimed to increase machine efficiency and provide a better cleaning performance by accelerating the liquid passage/flow of the filter (sponge filter) with conical absorber protrusions positioned at the bottom with small geometric holes, compared to known filters.

The filter (sponge filter) has specially shaped conical absorbent protrusions positioned under the filter in order to transfer the washing liquid faster than known filters through small geometrically shaped holes in its body. This conical filter with absorbent protrusions and small holes (sponge filter) is characterized in that it can transfer the washing liquid faster than known filters.

Our invention has a body made of thermoplastic polymer that is resistant to corrosion and oxidation. It is characterized in that it has innovative conical absorber structure, protrusions and small geometric porous shape, and is a higher efficiency filter that provides faster flow through smaller holes compared to other known filter structures in the field.

### DETAILED DESCRIPTION OF THE INVENTION

In accordance with the present invention, an effective filter (sponge filter) shape with a stepped and conical structure with geometrically shaped pores arranged to be placed on a tub at the bottom of the washing chamber where the washing liquid is discharged has been created. The filter (sponge filter) is such that it collects the food particles in the washing liquid by quickly separating them from the washing liquid and transfers the washing liquid faster than known techniques. The filter (sponge filter) is characterized in that it is a filter (sponge filter) whose pores are specially shaped in a conical structure, with a gradual and geometric shape, which separates and filters the washing liquid and directs it to the circulation pump freely and quickly, allowing the circulation to continue perfectly and quickly.

### BRIEF DESCRIPTION OF DRAWINGS

FIG. 1—Sponge Filter Cross Section

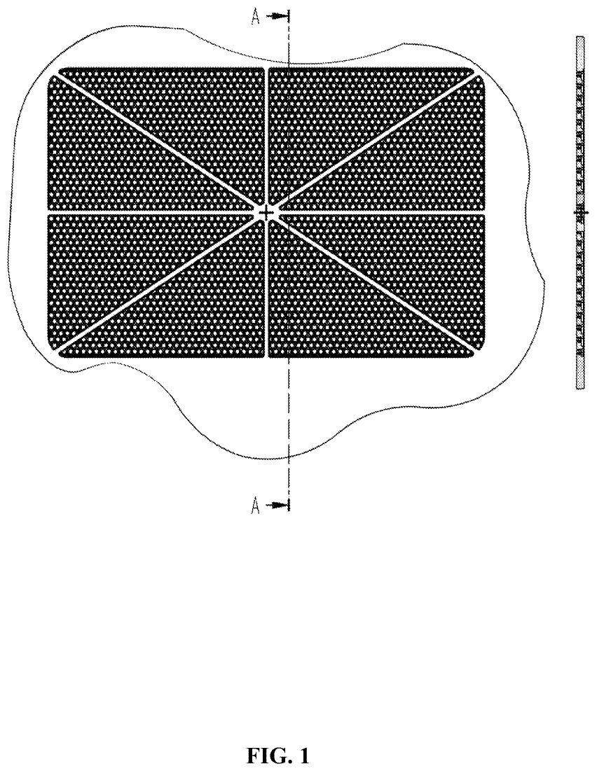

FIG. 2—Sponge Filter Front

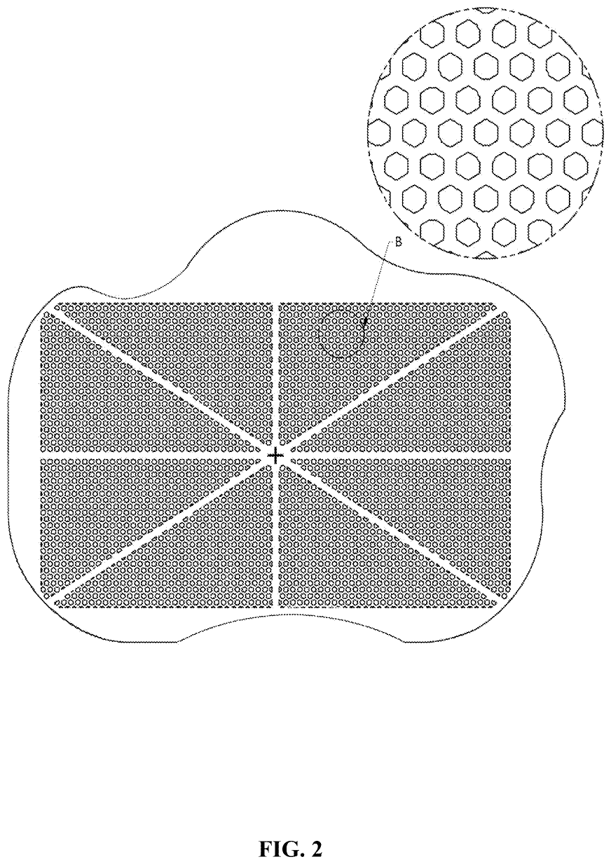

FIG. 3—Sponge Filter Rear

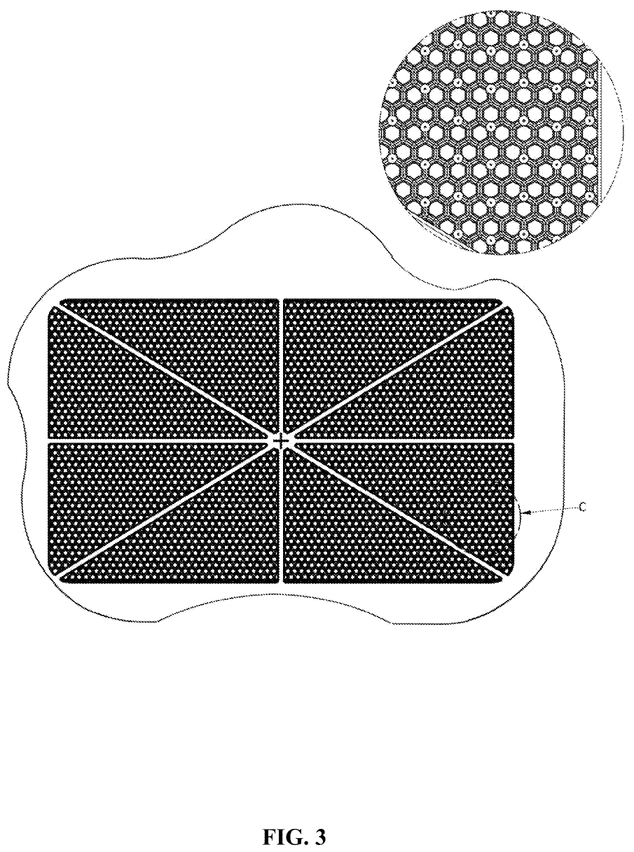

FIG. 4—Sponge Filter Isometric Perspective

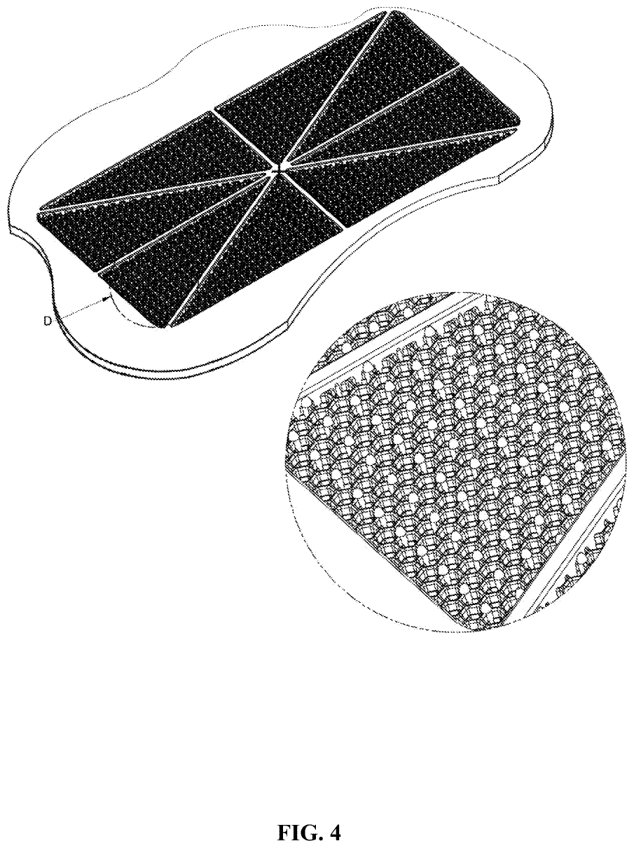

In existing products, it is necessary to keep the hole diameters large for the rapid passage of water, which causes the residues to pass through the filter and the washing liquid cannot be filtered, reducing the cleaning performance of the machine. When the holes are made smaller, the water is filtered better and the dishes are cleaned better, but the passage speed of the water decreases, reducing the efficiency of the machine. With this invention, it is aimed to increase machine efficiency and provide a better cleaning performance by accelerating the liquid passage/flow of the filter (sponge filter) with conical absorber protrusions positioned at the bottom with small geometric holes, compared to known filters.

The filter (sponge filter) has specially shaped conical absorbent protrusions positioned under the filter in order to transfer the washing liquid faster than known filters through small geometrically shaped holes in its body. This conical filter with absorbent protrusions and small holes (sponge filter) is characterized in that it can transfer the washing liquid faster than known filters.

The filter (sponge filter) is such that it fits perfectly into the section shaped for it, in the section passing to the drain outlet, on the tub located at the bottom of the washing chamber. It has conical absorbent protrusions and geometrically shaped small pores, so that the food particles collected on the sieve surface are retained on the surface and forced to collect in this recessed area immediately adjacent to the drainage outlet. Meanwhile, the filter (sponge filter) allows the washing liquid to flow freely by quickly filtering out of the chamber towards the circulation pump with the help of its conical absorber protrusions. In this outer space is the inlet of the pump, which recirculates the washing liquid, so that it receives the washing liquid itself only with entrained particles of much smaller sizes, but the larger sized particles are effectively and quickly separated by the filter (sponge filter).

The filter's (sponge filter) conical absorber protrusions and small pores in a geometric structure, has a location mounted on the lower tub within the washing chamber, to collect large food particles that cannot pass through the filter and to prevent such residues from passing to the circulation pump. The conical absorber protrusions and geometric small holes of the filter are generally large enough to circulate in the washing liquid and allow much smaller particles to pass through the washing liquid without causing any problems in the system. Therefore, during the washing stage, food particles are continuously and rapidly separated from the circulating liquid and collected in the pores of this filter (sponge filter) positioned just above its opening. In this way, after the washing process, the machine is stopped and the food particles that cannot pass through the filter (sponge filter) are removed and cleaned/washed. In this way, it provides a cleanable sieve assembly that contributes to clean clarification of the dishes with each wash and makes it much easier to keep the dishwasher itself in a clean and sanitary condition. The filter (sponge filter) made of thermoplastic polymer raw materials is characterized in that it is a more resistant, durable and long-lasting filter (sponge filter) than the known structures in the field.

What is claimed is:

1. A filter (sponge filter) for use in dishwashers and similar appliances having a liquid spray system, a liquid circulation system and a liquid filtration system, comprising conically shaped absorbent protrusions positioned under the filter to transfer the washing liquid faster than known filters through the small geometrically shaped holes in the filter (sponge filter) body.

2. A filter (sponge filter) for use in dishwashers and similar appliances having a liquid spray system, a liquid circulation system and a liquid filtration system, characterized in that, it is a filter (sponge filter) that is placed in the circulation flow path to pass the liquid faster, compared known filtering methods, and liquid passageways in the body of which are conically shaped, for use in washing machines, dryers and similar washing machines.

3. A filter (sponge filter) for use in dishwashers and similar appliances having a liquid spray system, a liquid circulation system and a liquid filtration system, characterized in that, the filter (sponge filter) pores, with their specially shaped absorbent protrusions in conical structure and small geometric pores, separates and filters the washing liquid and directs it freely and quickly to the circulation pump, ensuring that the circulation continues perfectly and quickly.

4. A filter (sponge filter) for use in dishwashers and similar appliances having a liquid spray system, a liquid circulation system and a liquid filtration system, characterized in that, it is a filter with faster flow and higher efficiency than other known filter structures in the field with its innovative shape having absorbent protrusions in a conical structure, and small geometric pores.

5. A filter (sponge filter) for use in dishwashers and similar appliances having a liquid spray system, a liquid circulation system and a liquid filtration system, characterized in that it is a filter made of thermoplastic polymer raw materials (sponge filter).

6. A filter (sponge filter) for use in dishwashers and similar appliances having a liquid spray system, a liquid circulation system and a liquid filtration system, characterized in that, it is a filter that fits perfectly into the section shaped for it in the section passing to the drainage outlet, and consists of conical absorbent protrusions and geometrically shaped small pores.
